(19) United States
(12) Patent Application Publication
(10) Pub. No.: US 2011/0043721 A1
(43) Pub. Date: Feb. 24, 2011

(54) BACK LIGHT ASSEMBLY AND LIQUID CRYSTAL DISPLAY INCLUDING THE SAME

(75) Inventors: Ju Seong Hwang, Cheonan-si (KR); Hyeong Sik Choi, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/815,572

(22) Filed: Jun. 15, 2010

(30) Foreign Application Priority Data
Aug. 18, 2009 (KR) 2009-76441
Aug. 31, 2009 (KR) 2009-81668

(51) Int. Cl. G02F 1/1333; F21V 7/22; G02F 1/1335

(52) U.S. Cl. 349/58; 362/611; 362/606; 349/62

(57) ABSTRACT

A back light assembly having uniform interior temperature to prevent quality deterioration of a liquid crystal display and a liquid crystal display including the same includes a light guide plate, a light source unit to emit light to an edge of the light guide plate, a lower cover to receive the light guide plate and the light source unit, heat generated from the light source unit being transferred to the lower cover, and a heat insulator provided adjacent to at least one region of the lower cover in an area to correspond to the light source unit.

### CROSS-REFERENCE TO RELATED APPLICATIONS

This application claims priority under 35 U.S.C. §119 from Korean Patent Application No. 2009-0076441, filed on Aug. 18, 2009 and Korean Patent Application No. 2009-0081668, filed on Aug. 31, 2009 in the Korean Intellectual Property Office, the disclosure of which is incorporated herein by reference in its entirety.

### BACKGROUND

1. Field of the General Inventive Concept

Embodiments of the present general inventive concept relate to a back light assembly having uniform interior temperature to prevent quality deterioration of a liquid crystal display and a liquid crystal display including the same.

2. Description of the Related Art

A liquid crystal display (LCD) displays an image using electrical and optical characteristics of a liquid crystal. The LCD has a smaller thickness and weight than other displays. Also, the LCD has a lower power consumption and driving voltage than other displays. Therefore, the LCD has been widely used over the whole field of industry.

The LCD includes a liquid crystal panel having a liquid crystal placed between two transparent substrates. Directions of liquid crystal molecules are changed by applying a voltage to the liquid crystal to change the optical transmissivity such that an image is optically displayed on the liquid crystal panel. Also, the LCD includes a back light assembly to supply light to the liquid crystal panel recently, and continues to grow in use.

The back light assembly uses a cold cathode fluorescent lamp (CCFL), an external electrode fluorescent lamp (EEFL), a flat fluorescent lamp (FFL), etc. as a light source. In recent years, however, light emitting diodes (LEDs) exhibiting high brightness, long life span and high color purity have been used as a light source of the back light assembly due to limitations of the CCFL in terms of high quality and reduction in weight and size of a device employing the back light assembly. Furthermore, the use of the CCFL has decreased due to strict regulations on environmentally toxic materials, such as mercury, and the use of the LEDs, which are environmentally-friendly parts, is on the rise.

Based on LED arrangement and shape of a light guide plate, a back light assembly employing LEDs as a light source may be classified as a direct type LED back light assembly or an edge type LED back light assembly. In the direct type LED back light assembly, the LEDs are disposed at the front of the back light assembly, with the result that the direct type LED back light assembly may not have a small thickness. Also, the direct type LED back light assembly uses an excessive number of LEDs, with the result that costs of the direct type LED back light assembly increase.

In the edge type LED back light assembly, on the other hand, LEDs are mounted at the side of the light guide plate such that light is emitted to the front of the back light assembly through the light guide plate, with the result that the edge type LED back light assembly has a smaller thickness than the direct type LED back light assembly.

In the edge type LED back light assembly, however, regions where a relatively large number of LEDs are disposed have higher temperatures than other regions where a relatively small number of LEDs are disposed, with the result that the interior temperature of the back light assembly is not uniformly maintained. The nonuniform interior temperature of the back light assembly affects a polarizing plate of a liquid crystal panel, causing light leakage from the liquid crystal panel, thereby deteriorating quality of a liquid crystal display employing the back light assembly.

### SUMMARY

Therefore, features and utilities of the present general inventive concept provide a back light assembly having uniform interior temperature to achieve uniform brightness of a liquid crystal panel, and a liquid crystal display including the same.

Additional features and utilities of the present general inventive concept will be set forth in part in the description which follows and, in part, will be obvious from the description, or may be learned by practice of the general inventive concept

Embodiments of the present general inventive concept may be achieved by providing a back light assembly including a light guide plate, a light source unit to emit light to an edge of the light guide plate, a lower cover to receive the light guide plate and the light source unit, heat generated from the light source unit being transferred to the lower cover, and a heat insulator provided adjacent at least one region of the lower cover in an area to correspond to the light source unit.

The back light assembly may further include a carrier member to transfer heat generated from the light source unit to the lower cover, and the heat insulator may be provided at a region of the carrier member and the lower cover.

The light source unit may include a plurality of light source units disposed at four side edges of the lower cover, the carrier member may include a plurality of carrier members disposed at the four side edges of the lower cover to transfer heat generated from the light source units to the lower cover, and the heat insulator may include a plurality of heat insulators attached to correspond to corners of the lower covers.

The back light assembly may further include a reflective sheet provided between the light guide plate and the lower cover, and the heat insulator may be provided between the reflective sheet and the lower cover.

The carrier member may include a support to support the light source unit and a heat sink to transfer heat generated from the light source unit to the lower case.

The heat insulator may be formed of one selected from a group consisting of plaster, texture, rubber, and graphite.

The heat insulator may include a tape to enable the heat insulator to be attached to the lower cover.

The light source unit may include a printed circuit board supported at an edge of the lower cover by the carrier member and a light emitting diode mounted to the printed circuit board.

Embodiments of the present general inventive concept may also be achieved by providing a liquid crystal display including a liquid crystal panel to display an image and a back light assembly to supply light to the liquid crystal panel, and the back light assembly includes a light guide plate, a plurality of light source units to emit light to incidence surfaces of the light guide plate, a lower cover to receive the light guide plate and the light source units, heat generated from the light source units being transferred to the lower cover, and a heat insulator provided adjacent at least one region of the lower cover to prevent heat transferred to the lower cover from being transferred to the liquid crystal panel.

The back light assembly may further include a plurality of carrier members to transfer heat generated from the light source units to the lower cover, and the heat insulator may be provided adjacent at least one region of the carrier members and the lower cover to prevent heat transferred to the carrier members and the lower cover from being transferred to the liquid crystal panel.

Each of the light source units may include a printed circuit board supported by a corresponding one of the carrier members, the printed circuit board extending along a corresponding one of the incidence surfaces, and a light emitting diode mounted to the printed circuit board.

The printed circuit board may be coupled to the corresponding carrier member at a corresponding side edge of the lower cover, and the heat insulator may be attached to a corner of the lower cover where the neighboring printed circuit boards are adjacent to each other.

The back light assembly may further include a reflective sheet to reflect some of the light emitted from the light source units to the light guide plate, and the heat insulator may be attached to a top of the lower cover such that the heat insulator is in tight contact with a bottom of the reflective sheet.

The heat insulator may be formed of one selected from a group consisting of acrylic resin, polyurethane, polystyrene, and graphite.

Embodiments of the present general inventive concept may also be achieved by providing a display including a signal processing unit to process a video signal and an audio signal received from an external source, a liquid crystal panel to display a video signal supplied from the signal processing unit, and a back light assembly to supply light to the liquid crystal panel, and the back light assembly includes a light guide plate, a plurality of light source units to emit light to incidence surfaces of the light guide plate, a lower cover to receive the light guide plate and the light source units, heat generated from the light source units being transferred to the lower cover, and a heat insulator provided adjacent at least one region of the lower cover to prevent heat transferred to the lower cover from being transferred to the liquid crystal panel.

Embodiments of the present general inventive concept may also be achieved by providing an upper cover to cover a front of a liquid crystal display panel, a lower cover in contact with the upper cover to cover a back of the liquid crystal display panel and having a plurality of side walls, a light source unit disposed adjacent to a first side wall of the lower cover, and a first carrier member in contact with an upper edge of the first side wall of the lower cover and the first light source unit to transfer heat generated from the first light source unit to the lower cover.

A second light source unit may be disposed adjacent a second side wall of the lower cover, and a second carrier member in contact with an upper edge of the second side wall of the lower cover and the second light source to transfer heat generated from the second light source unit to the lower cover.

A plurality of heat insulators may be in contact with the first and second carrier members and the lower cover to prevent heat from the first and second light sources from being transferred to the liquid crystal display panel.

Embodiments of the present general inventive concept may also be achieved by providing an upper cover and a lower cover to cover a liquid crystal display panel, the lower cover having an inside edge extending between a plurality of corners of the lower cover, a light source unit extending along the inside edge of the lower cover to emit light to the liquid crystal display panel, a heat sink extending along the inside edge of the lower cover and adjacent to the plurality of corners to remove heat generated by the light source unit from the liquid crystal display apparatus, and a plurality of heat insulators disposed adjacent to the plurality of corners to prevent the heat generated by the light source unit from being transferred from the plurality of corners to the liquid crystal display panel.

The heat sink may contact the light source unit and the plurality of heat insulators do not contact the light source unit.

Embodiments of the present general inventive concept may also be achieved by providing a first and second cover in which to mount a light guide plate and a liquid crystal display panel, the light guide plate having an edge, a light source unit disposed between the first cover and the second cover, the light source unit extending along the edge of the light guide plate to emit light to the light guide plate, a heat sink including a first portion in contact with the light source unit and a second portion in contact with the second cover to transfer heat from the light source unit to the second cover, and a mold frame disposed above the light guide plate and below the liquid crystal display panel to provide support and framing for the liquid crystal display panel and the light guide plate.

The mold frame may be disposed between the light source unit and the second cover. The mold frame may be disposed between the first heat sink portion and the second heat sink portion.

A heat insulator may be disposed adjacent the light source unit and covering a portion of the heat sink and the second cover to prevent heat from the light source unit from being transferred to the liquid crystal panel.

### BRIEF DESCRIPTION OF THE DRAWINGS

These and/or other features and utilities of the general inventive concept will become apparent and more readily appreciated from the following description of the embodiments, taken in conjunction with the accompanying drawings of which:

FIG. 1 is a perspective view illustrating a liquid crystal display according to an embodiment of the present general inventive concept;

FIG. 2 is an exploded perspective view illustrating part of a back light assembly illustrated in FIG. 1;

FIG. 3 is a plan view illustrating part of the back light assembly of FIG. 1;

FIG. 4 is a sectional view taken along line IV-IV′ of FIG. 1;

FIG. 5 is a sectional view illustrating a modified arrangement example of a light source unit according to an embodiment of the present general inventive concept;

FIG. 6 is a sectional view illustrating another modified arrangement example of the light source unit according to the embodiment of the present general inventive concept;

FIG. 7 is a construction view illustrating a display apparatus as a display using a liquid crystal display according to an embodiment of the present general inventive concept; and

FIG. 8 is an exterior view illustrating a display apparatus as a display according to an embodiment of the present general inventive concept

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

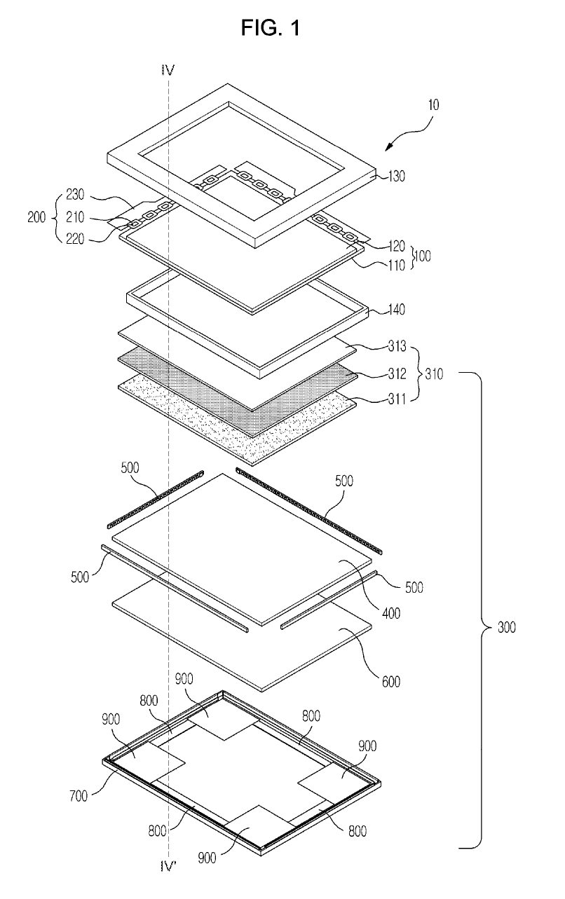

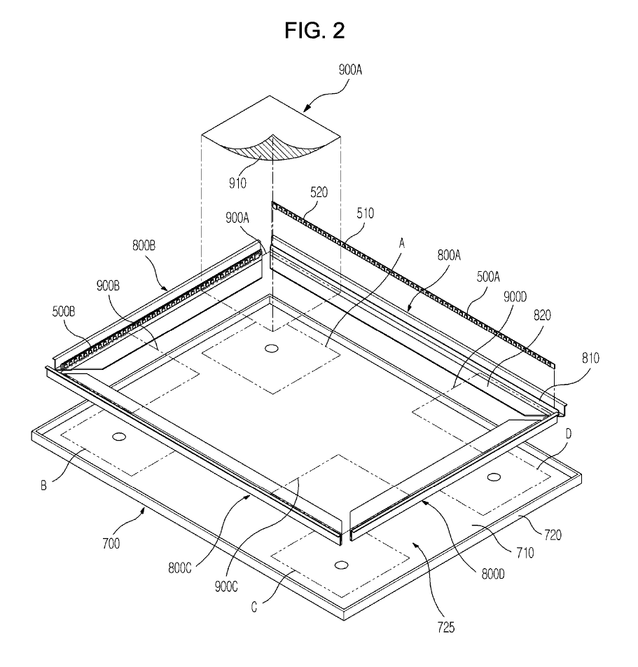

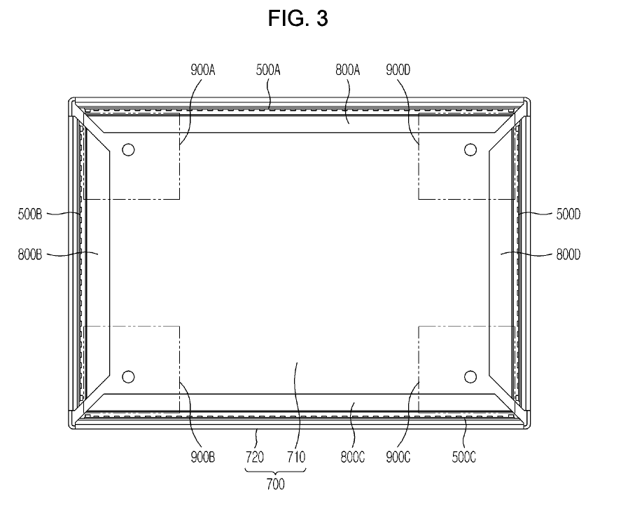

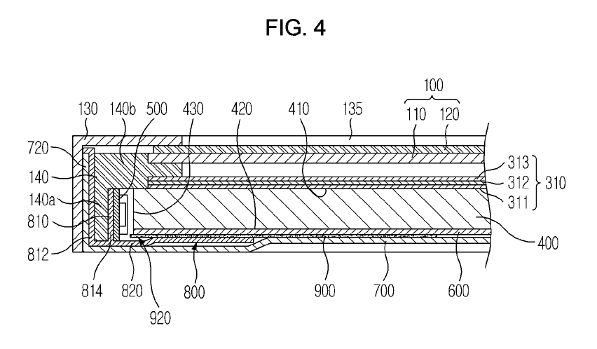

FIG. 1 is a perspective view illustrating a liquid crystal display 10 according to an embodiment of the present general inventive concept, FIG. 2 is an exploded perspective view illustrating part of a back light assembly illustrated in FIG. 1, FIG. 3 is a plan view illustrating part of the back light assembly of FIG. 1, and FIG. 4 is a sectional view taken along line IV-IV′ of FIG.

As illustrated in FIGS. 1 to 4, the liquid crystal display 10 includes a liquid crystal panel 100 on which an image is formed, a drive unit 200 connected to one side of the liquid crystal panel 100 to drive the liquid crystal panel 100, and a back light assembly 300 to irradiate light to the liquid crystal panel 100.

An edge of the liquid crystal panel 100 may be supported by a mold frame 140. The liquid crystal panel 100 is received in the mold frame 140. The mold frame 10 may be partially open to transmit light emitted from the back light assembly 300.

The mold frame 140 and the back light assembly 300 may be coupled to an upper cover 130 to cover the front of the liquid crystal panel 100. The upper cover 130 serves to cover the liquid crystal panel 100 such that an effective display area of the liquid crystal panel 100 where an image is displayed is exposed. The upper cover 130 guides the position of the liquid crystal panel 100 and fixes the liquid crystal panel 100 to the mold frame 140.

Between the upper cover 130 and the liquid crystal panel 100 is a transparent cover 135 to form an outer shell and protect the liquid crystal panel 100 and internal components from the external environment.

The liquid crystal panel 100 includes a thin film transistor substrate 110, a color filter substrate 120 opposite to the thin film transistor substrate 110, and a liquid crystal (not illustrated) placed between the thin film transistor substrate 110 and the color filter substrate 120. The liquid crystal panel 100 adjusts optical transmissivity of liquid crystal cells, according to image signal information transmitted from the drive unit 200, to form an image.

The drive unit 200 may be provided at one side of the thin film transistor substrate 110 to apply a drive signal to the liquid crystal panel 100. The drive unit 200 includes a flexible printed circuit board 210, a drive chip 220 mounted to the flexible printed circuit board 210, and a circuit board 230 connected to the flexible printed circuit board 210.

The back light assembly 300 may be located at the rear of the liquid crystal panel 100. The back light assembly 300 may include optical sheets 310 stacked on the rear of the liquid crystal panel 100 to diffuse and condense light, a light guide plate 400 disposed at the rear of the optical sheets 310, a light source unit 500 provided along the edge of the light guide plate 400 to emit light to the liquid crystal panel 100, a reflective sheet 600 provided at the rear of the light guide plate 400, a lower cover 700 to receive the light guide plate 400 and the reflective sheet 600, and a carrier member 800 to transfer heat generated from the light source unit 500 to the lower cover 700.

The optical sheets 310, disposed at the rear of the liquid crystal panel 100 in parallel, include a diffusion sheet 311, a prism sheet 312, and a protective sheet 313, which are consecutively stacked. The diffusion sheet 311 includes a base film (not illustrated) and a diffusion coating layer (not illustrated) formed at the front of the base film. The diffusion sheet 311 serves to diffuse light emitted from the light source unit 500 and to supply the diffused light to the liquid crystal panel 100.

The prism sheet 312 and the protective sheet 313 are provided on the diffusion sheet 311. The prism sheet 312 has prisms arranged on the top thereof in a predetermined pattern. The prism sheet 312 allows light transmitted through the diffusion sheet 311 to advance perpendicularly to improve brightness. The protective sheet 313 is provided on the prism sheet 312 to prevent external impact from being applied to the diffusion sheet 311 and the prism sheet 312 or to prevent external foreign matter from being introduced to the diffusion sheet 311 and the prism sheet 312, thereby protecting the diffusion sheet 311 and the prism sheet 312, which are sensitive to dust and scratches.

The light guide plate 400 has an exit surface 410 facing the liquid crystal panel 100, a reflection surface 420 opposite to the exit surface 410, and incidence surfaces 430 connected between the exit surface 410 and the reflection surface 420 while facing the light source unit 500.

The light guide plate 400 may be formed of polymethyl methacrylate (PMMA) having high strength, so as not to be easily deformed or broken, and high transmissivity. The light guide plate 400 may be of a plate type in which the exit surface 410 and the reflection surface 420 are disposed in parallel.

The light source unit 500 includes a plurality of light source units provided at the edge of the lower cover 700 such that the light source units 500 face the corresponding incident surfaces 430 of the light guide plate 400. For example, the light source units 500 may be disposed along the edge of the lower cover 700. That is, the light source units 500 may be disposed at four side edges of the lower cover 700.

As illustrated in FIGS. 2 and 3, the light source units 500 may include a first light source unit 500A disposed at the upper edge of the lower cover 700, a second light source unit 500B disposed at the left edge of the lower cover 700, a third light source unit 500C disposed at the lower edge of the lower cover 700, and a fourth light source unit 500D disposed at the right edge of the lower cover 700.

The first light source unit 500A, the second light source unit 500B, the third light source unit 500C, and the fourth light source unit 500D may have the same construction. Therefore, only the first light source unit 500A will be described hereinafter in detail, and descriptions of the second to fourth light source units 500B to 500D will not be given.

As illustrated in FIG. 2, the first light source unit 500A includes a printed circuit board 510 and a light emitting diode 520 mounted to the printed circuit board 510. The printed circuit board 510 is formed in the shape of a long bar facing the corresponding incidence surface 430. The printed circuit board 510 may be mainly formed of aluminum exhibiting high thermal conductivity to conduct heat generated from the first light source unit 500A. The printed circuit board 510 may be embodied by various printed circuit boards, such as a metal core printed circuit board, a hard printed circuit board or a flexible printed circuit board.

A light emitting diode 520 may include a plurality of light emitting diodes arranged on the printed circuit board 510 at regular intervals. The respective light emitting diodes 520 may be white light supply units including blue, red and green light emitting diodes to supply white light.

The reflective sheet 600 reflects light emitted from the light source units 500 and discharged in the direction opposite to the liquid crystal panel 100 to the light guide plate 400 to reduce light loss. The reflective sheet 600 may be formed of polyethylene terephthalate (PET) or poly carbonate (PC).

As illustrated in FIG. 2, the lower cover 700 is located below the reflective sheet 600. The lower cover 700 may be formed in the shape of a rectangular parallel-piped box, open at the top thereof such that the lower cover 700 has a receiving space 725 of a predetermined depth. That is, the lower cover 700 includes a base plate 710 and a plurality of side walls 720 perpendicularly extending from the base plate 710. The receiving space 725 is defined by the base plate 710 and the side walls 720.

The reflective sheet 600, the light guide plate 400, and the optical sheets 310 are consecutively received in the receiving space 725 of the lower cover 700. The base plate 710 of the lower cover 700 is partially open such that heat generated from the light source units 500 is rapidly discharged outside.

A carrier member 800 is provided between the lower cover 700 and the light source units 500. The carrier member 800 can be formed of a hard metal material, such as aluminum, to support the light source units 500 and, at the same time, to transfer heat generated from the light source units 500 to the lower cover 700.

As illustrated in FIGS. 2 and 3, the carrier member 800 includes a first carrier member 800A corresponding to the first light source unit 500A, a second carrier member 800B corresponding to the second light source unit 500B, a third carrier member 800C corresponding to the third light source unit 500C, and a fourth carrier member 800D corresponding to the fourth light source unit 500D.

The first carrier member 800A may be fixed to the upper edge of the lower cover 700 to support the first light source unit 500A and to transfer heat generated from the first light source unit 500A to the lower cover 700. The second carrier member 800B is fixed to the left edge of the lower cover 700 to support the second light source unit 500B and to transfer heat generated from the second light source unit 500B to the lower cover 700.

Also, the third carrier member 800C is fixed to the lower edge of the lower cover 700 to support the third light source unit 500C and to transfer heat generated from the third light source unit 500C to the lower cover 700. The fourth carrier member 800D is fixed to the right edge of the lower cover 700 to support the fourth light source unit 500D and to transfer heat generated from the fourth light source unit 500D to the lower cover 700.

The first carrier member 800A, the second carrier member 800B, the third carrier member 800C, and the fourth carrier member 800D have the same construction. Therefore, only the first carrier member 800A will be described hereinafter in detail, and descriptions of the second to fourth carrier members 800B to 800D will not be given.

As illustrated in FIG. 4, the first carrier member 800A may include a support 810 to support the first light source unit 500A and a heat sink 820 to transfer heat generated from the first light source unit 500A to the lower case 700. The lower 700 case then transfers the heat to the outside environment.

The support 810 may protrude in parallel portions to correspond to the side walls 720 of the lower cover 700. Below the support 810, the heat sink 820 may extend from the base plate 710 of the lower cover 700 along the corresponding side wall 720. The support 810 and the heat sink 820 may be integrally formed by injection-molding a hard metal material, such as aluminum. Thus, the support 810 is also a heat sink that transfers heat from the light sources 500 through the upper and lower covers 700 and 300 to the external environment.

The parallel portions of the support 810 may include a first sub portion 812 to extend substantially the same height as the upper cover and a second sub portion 814 to be substantially the same height as the light source unit 500. The first and second sub portions 812 and 814 enclose a portion 140a of the mold portion on three sides thereof. A second portion 140b of the mold frame 140 may be disposed above the light source 500 and adjacent the first and second sub portions 812 and 814 of the support 810. The lower portion 140a of the mold frame 140 may be positioned between the side wall 720 and the light source 500. Thus, the mold frame 140 may be disposed adjacent multiple sides of the light source units 500 to provide support and framing for the light guide plate 400 and liquid crystal display panel 100.

To the lower cover 700 is attached a heat insulator 900 to prevent heat transferred from the first to fourth light source units 500 to the lower cover 700 from being transferred to the liquid crystal panel 100 by heat radiation or convection to uniformly maintain the interior temperature of the back light assembly 300.

In this example embodiment, the heat insulator 900 is formed of a material having high heat insulation efficiency. The heat insulator 900 may be formed of, for example, graphite, plaster, texture, rubber, reflective sheet, acrylic resin, polyurethane, polystyrene, etc. The heat insulator 900 may include a heat sink material to rapidly discharge heat generated from the light source units 500 out of the liquid crystal display 10 and a heat transfer preventing material to prevent heat generated from the light source units 500 from being transferred into the liquid crystal display 10.

As illustrated in FIGS. 2 and 3, the heat insulator 900 may include a first heat insulator 900A to insulate heat generated from a left upper corner A of the lower cover 700 where the first light source unit 500A and the second light source unit 500B are adjacent to each other, a second heat insulator 900B to insulate heat generated from a left lower corner B of the lower cover 700 where the second light source unit 500B and the third light source unit 500C are adjacent to each other, a third heat insulator 900C to insulate heat generated from a right lower corner C of the lower cover 700 where the third light source unit 500C and the fourth light source unit 500D are adjacent to each other, and a fourth heat insulator 900D to insulate heat generated from a right upper corner D of the lower cover 700 where the fourth light source unit 500D and the first light source unit 500A are adjacent to each other.

The first to fourth heat insulators 900A to 900D each may include a tape 910 by which the first to fourth heat insulators 900A to 900D are attached to the base plate 710 of the lower cover 700.

The operation of the back light assembly and the liquid crystal display including the same will be additionally described.

As the first to fourth light source units 500 emit light, heat is generated from the first to fourth light source units 500. Heat from the light source units 500 is conducted to the first to fourth carrier members 800. The heat conducted to the first to fourth carrier members 800 is discharged outside through the lower cover 700 coupled to the first to fourth carrier members 800 through the heat sinks 820.

Relatively high or increased temperatures may appear at the respective corners A, B, C, and D of the lower cover 700 where the neighboring light unit sources 500 are adjacent to each other. Although the temperatures at the respective corners A, B, C, and D of the lower cover 700 are nonuniform, however, the heat insulators 900 prevent heat from being transferred from the respective corners A, B, C, and D of the lower cover 700 to the liquid crystal panel 100 by heat radiation or convection.

Also at the corners, the heat sinks 820 come together to form dual heat sinks to correspond to the temperatures at the corners. Thus, along with the heat insulators 900, the coming together of the heat sinks at each corner provides significant heat conduction to lower or offset the heat that may accumulate at each corner as a result an increase in heat from the light sources at the respective corners.

As illustrated in FIG. 4, inside, outer, or corner ends/edges 920 of the heat insulators 900 are positioned adjacent, but not touching the light source units 500. An end of the heat insulator 920 may protrude or extend past the incident surfaces 430 towards the light source unit 500 a greater distance than the light guide plate 400. As a result of this configuration, the heat insulators 900 do not prevent heat from radiating downward to the heat sinks 820, yet at the same time prevents heat from being transferred from the corners to the liquid crystal panel 100.

Therefore, the interior temperature of the back light assembly 300 may be uniformly maintained even at the regions where the neighboring light unit sources 500 are adjacent to each other, thereby achieving uniform brightness of the liquid crystal panel 100.

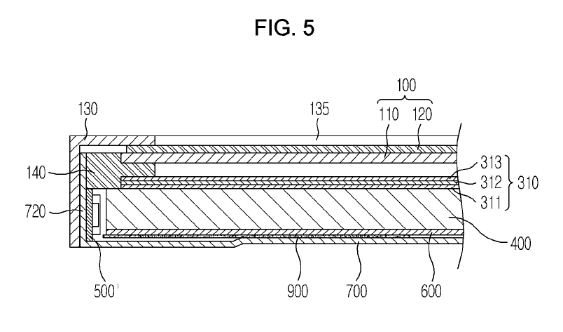

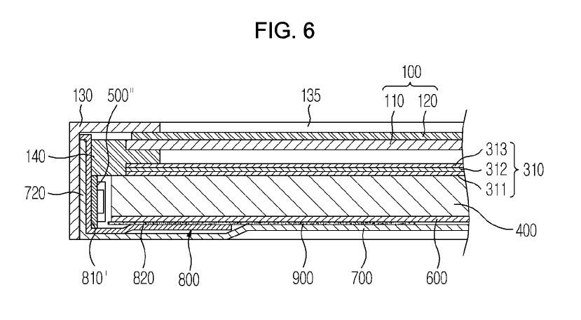

The light source unit may be coupled to the lower cover in various ways. FIG. 5 is a sectional view illustrating a modified arrangement example of the light source unit, and FIG. 6 is a sectional view illustrating another modified arrangement example of the light source unit.

As illustrated in FIG. 5, a light source unit 500′ may be directly supported at the corresponding side wall 720 of the lower cover 700. Also, as illustrated in FIG. 6, a light source unit 500″ may be supported between the support 810′ of the corresponding carrier member 800 and the corresponding side wall 720 of the lower cover 700 without an additional space.

In FIGS. 5 and 6, the mold frame 140 may be disposed above the light sources 500 and adjacent an upper portion of the support 810′. Such a configuration may allow more space to allow the light guide plates 400 and the covers 130 to allow more of the LCD screen to be used for displaying images.

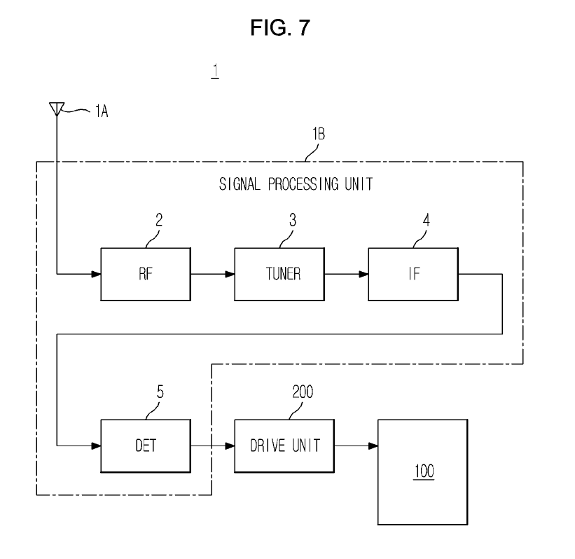

FIG. 7 is a construction view illustrating a display apparatus as a display using a liquid crystal display according to an embodiment of the present general inventive concept.

As illustrated in FIG. 7, a display apparatus 1 may include a computer monitor, a television monitor, flat screen of a digital camera, video camera, cellular telephone, and other displays using LCD screens and backlights such as displays on photocopiers, faxes, multifunction devices, etc.

When a display apparatus 1 may be a television set for example, an external signal may be received by an antenna 1A from a television broadcast antenna, from a local cable operator, or from a cable or television converter within a user's home or business. The transmission signal may be input by the display apparatus 1 into an RF receiver 2. The input signals received by the RF receiver 2 may be transmitted to a tuner 3 in order to filter out undesired signals. Audio, video, control, and other signals may then be passed though an intermediate frequency module 4 to a detector 5 to further filter signals to be reproduced on the LCD panel.

After passing through these several components the amplitude of the image data signals may be weakened and thus the drive unit 200 amplifies and outputs the signals to drive the liquid crystal panel 100. The internal control of the display apparatus may be controlled by a controller (not illustrated) internal to the display apparatus. Control of the components of the display apparatus 1 may also be embedded in a received signal from an external controller.

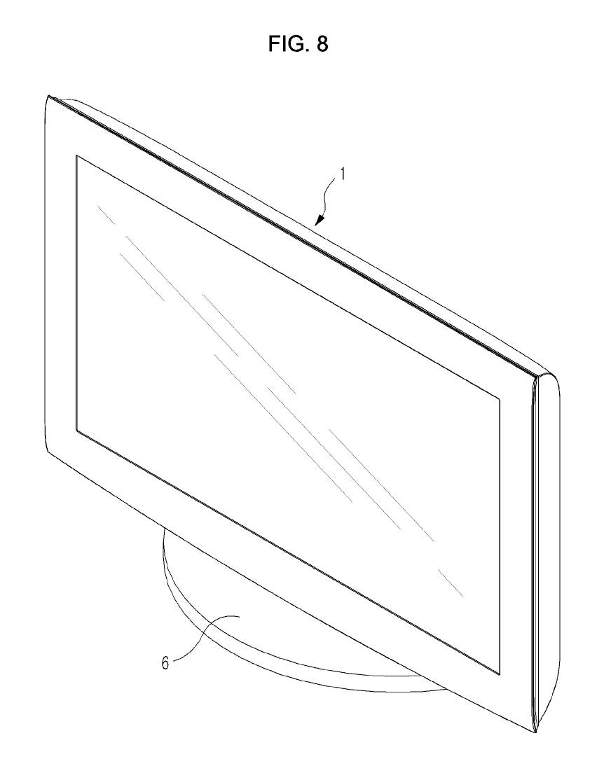

FIG. 8 is an exterior view illustrating the display apparatus 1 as a display according to an embodiment of the present general inventive concept. As illustrated, the display apparatus 1 may be mounted on a stand 6 to support the display apparatus. The display apparatus may alternatively be mounted on a wall, hung from a ceiling, or mounted on other types of base members.

In example embodiments of the present general inventive concept, the back light assembly and the liquid crystal display including the same have a fundamental technical concept in that the heat insulators are provided at the regions where the neighboring light unit sources are adjacent to each other to uniformly maintain the interior temperature of the back light assembly.

As is apparent from the above description, heat conducted to the lower cover is prevented from being transferred to the liquid crystal panel by the heat insulators disposed adjacent to the light source units, thereby uniformly maintaining the interior temperature of the back light assembly and thus achieving uniform brightness of the liquid crystal panel of the liquid crystal display including the back light assembly.

Although a few embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A back light assembly comprising:
a light guide plate;
a light source unit to emit light to an edge of the light guide plate;
a lower cover to receive the light guide plate and the light source unit, heat generated from the light source unit being transferred to the lower cover; and
a heat insulator provided adjacent to at least one region of the lower cover in an area to correspond to the light source unit.

2. The back light assembly according to claim 1, further comprising:
a carrier member to transfer heat generated from the light source unit to the lower cover, wherein
the heat insulator is provided at a region of the carrier member and the lower cover.

3. The back light assembly according to claim 2, wherein
the light source unit comprises a plurality of light source units disposed at four side edges of the lower cover,
the carrier member comprises a plurality of carrier members disposed at the four side edges of the lower cover to transfer heat generated from the light source units to the lower cover, and
the heat insulator comprises a plurality of heat insulators attached to correspond to corners of the lower covers.

4. The back light assembly according to claim 1, further comprising:
a reflective sheet provided between the light guide plate and the lower cover, wherein the heat insulator is provided between the reflective sheet and the lower cover.

5. The back light assembly according to claim 2, wherein the carrier member comprises:
a support to support the light source unit; and
a heat sink to transfer heat generated from the light source unit to the lower case.

6. The back light assembly according to claim 1, wherein the heat insulator is formed of one selected from a group consisting of plaster, texture, rubber, and graphite.

7. The back light assembly according to claim 1, wherein the heat insulator comprises a tape to enable the heat insulator to be attached to the lower cover.

8. The back light assembly according to claim 2, wherein the light source unit comprises:
a printed circuit board supported at an edge of the lower cover by the carrier member; and
a light emitting diode mounted to the printed circuit board.

9. A liquid crystal display apparatus comprising:
a liquid crystal panel to display an image; and
a back light assembly to supply light to the liquid crystal panel, wherein
the back light assembly comprises:
a light guide plate;
a plurality of light source units to emit light to incidence surfaces of the light guide plate;
a lower cover to receive the light guide plate and the light source units, heat generated from the light source units being transferred to the lower cover; and
a heat insulator provided adjacent to at least one region of the lower cover to prevent heat transferred to the lower cover from being transferred to the liquid crystal panel.

10. The liquid crystal display apparatus according to claim 9, wherein
the back light assembly further comprises a plurality of carrier members to transfer heat generated from the light source units to the lower cover, and
the heat insulator is provided adjacent to at least one region of the carrier members and the lower cover to prevent heat transferred to the carrier members and the lower cover from being transferred to the liquid crystal panel.

11. The liquid crystal display apparatus according to claim 10, wherein each of the light source units comprises:
a printed circuit board supported by a corresponding one of the carrier members, the printed circuit board extending along a corresponding one of the incidence surfaces; and
a light emitting diode mounted to the printed circuit board.

12. The liquid crystal display apparatus according to claim 11, wherein
the printed circuit board is coupled to the corresponding carrier member at a corresponding side edge of the lower cover, and
the heat insulator is attached to a corner of the lower cover where the neighboring printed circuit boards are adjacent to each other.

13. The liquid crystal display apparatus according to claim 9, wherein
the back light assembly further comprises a reflective sheet to reflect some of the light emitted from the light source units to the light guide plate, and
the heat insulator is attached to a top of the lower cover such that the heat insulator is in tight contact with a bottom of the reflective sheet.

14. The liquid crystal display apparatus according to claim 9, wherein the heat insulator is formed of one selected from a group consisting of acrylic resin, polyurethane, polystyrene, and graphite.

15. A liquid crystal display apparatus, comprising:
a signal processing unit to process a video signal and an audio signal received from an external source;
a liquid crystal panel to display a video signal supplied from the signal processing unit; and
a back light assembly to supply light to the liquid crystal panel, wherein
the back light assembly comprises:
a light guide plate;
a plurality of light source units to emit light to incidence surfaces of the light guide plate;
a lower cover to receive the light guide plate and the light source units, heat generated from the light source units being transferred to the lower cover; and
a heat insulator provided adjacent to least one region of the lower cover to prevent heat transferred to the lower cover from being transferred to the liquid crystal panel.

16. A liquid crystal display apparatus, comprising:
an upper cover to cover a front of a liquid crystal display panel;
a lower cover in contact with the upper cover to cover a back of the liquid crystal display panel and having a plurality of side walls;
a light source unit disposed adjacent to a first side wall of the lower cover; and
a first carrier member in contact with an upper edge of the first side wall of the lower cover and the first light source unit to transfer heat generated from the first light source unit to the lower cover.

17. The apparatus of claim 16, further comprising:
a second light source unit disposed adjacent a second side wall of the lower cover; and
a second carrier member in contact with an upper edge of the second side wall of the lower cover and the second light source to transfer heat generated from the second light source unit to the lower cover.

18. The apparatus of claim 17, further comprising a plurality of heat insulators in contact with the first and second carrier members and the lower cover to prevent heat from the first and second light sources from being transferred to the liquid crystal display panel.

19. A liquid crystal display apparatus, comprising:
an upper cover and a lower cover to cover a liquid crystal display panel, the lower cover having an inside edge extending between a plurality of corners of the lower cover;
a light source unit extending along the inside edge of the lower cover to emit light to the liquid crystal display panel;
a heat sink extending along the inside edge of the lower cover and adjacent to the plurality of corners to remove heat generated by the light source unit from the liquid crystal display apparatus; and
a plurality of heat insulators disposed adjacent to the plurality of corners to prevent the heat generated by the light source unit from being transferred from the plurality of corners to the liquid crystal display panel.

20. The apparatus of claim 19, wherein the heat sink contacts the light source unit and the plurality of heat insulators do not contact the light source unit.

21. A liquid crystal display apparatus, comprising:
a first and second cover in which to mount a light guide plate and a liquid crystal display panel, the light guide plate having an edge;
a light source unit disposed between the first cover and the second cover, the light source unit extending along the edge of the light guide plate to emit light to the light guide plate;
a heat sink including a first portion in contact with the light source unit and a second portion in contact with the second cover to transfer heat from the light source unit to the second cover; and
a mold frame disposed above the light guide plate and below the liquid crystal display panel to provide support and framing for the liquid crystal display panel and the light guide plate.

22. The apparatus of claim 21, wherein the mold frame is disposed between the light source unit and the second cover.

23. The apparatus of claim 22, wherein the mold frame is disposed between the first heat sink portion and the second heat sink portion.

24. The apparatus of claim 21, further comprising a heat insulator disposed adjacent the light source unit and covering a portion of the heat sink and the second cover to prevent heat from the light source unit from being transferred to the liquid crystal panel.
